(19) United States
(12) Patent Application Publication
(10) Pub. No.: US 2005/0275648 A1
(43) Pub. Date: Dec. 15, 2005

(54) Host device to display independent menu groups of driver registration information

(76) Inventor: Sang-jin Park, Suwon-si (KR)

Correspondence Address: STANZIONE & KIM, LLP, 919 18TH STREET, N.W., SUITE 440, WASHINGTON, DC, 20006, US

(21) Appl. No.: 11/147,176

(22) Filed: Jun. 8, 2005

(30) Foreign Application Priority Data
Jun. 9, 2004 (KR) 2004-42169

(51) Int. Cl. G09G 5/00

(52) U.S. Cl. 345/204; 358/1.15

(57) ABSTRACT

A host device includes one or more menu groups provided in a driver program to drive an external device connectable to the host device and to set driving options of the external device, a user interface section connected to the one or more menu groups to provide a user interface screen to independently display the one or more menu groups separately with respect to each other, and a display section to display the user interface screen provided by the user interface section. Accordingly, a user can conveniently set the driving options of the external device connectable to the host device after the driver program is installed in the host device without inconvenience caused by moving between menu groups.

### CROSS-REFERENCE TO RELATED APPLICATIONS

This application claims the benefit under 35 U.S.C. § 119 of Korean Patent Application No. 2004-42169, filed on Jun. 9, 2004, in the Korean Intellectual Property Office, the disclosure of which is incorporated herein in its entirety by reference.

### BACKGROUND OF THE INVENTION

1. Field of the Invention

The present general inventive concept relates to a host device having an improved method of displaying a user interface. More particularly, the present general inventive concept relates to a host device which allows independent menu groups of a user interface of a driver program installed in the host device to be entirely or selectively independently displayed on a display section, so that it is possible to move between the menu groups without clicking a desired menu group when setting options of the driver program.

2. Description of the Related Art

A host, such as a personal computer, a laptop computer and a personal digital assistant (PDA), is provided with a processor, a random-access memory (RAM), and a storage medium, as well as one or more driver programs for making the host recognize corresponding external devices (for example, a printer, a scanner, a mouse, a wired or wireless network interface card, a USB storage medium, etc.) so as to use the external devices. The driver programs make the host recognize the corresponding external devices wiredly or wirelessly connected to the host and interface the host and the external devices. In addition, through the driver programs, it is possible to set additional functions or driving modes of the external devices connected to the host. For example, if a printer driver program is installed in the host as one of the driver programs, a user can set various print options including print resolution and paper orientation through the printer driver program. Therefore, how user interface screens of the driver programs are displayed is important because the user interface screens allow the user to conveniently set one or more additional functions and driving modes of the driver programs through the user interface screens.

FIGS. 1A to 1C illustrate conventional printer user interface screens for the printer driver program.

FIG. 1A illustrates a user interface screen displayed on a display section when selecting driver registration information for a printer from a Windows series operation system (for example, WINDOWS 2000 PROFESSIONAL).

Referring to FIG. 1A, the user interface screen is provided with a general menu 10, a share menu 20, a port menu 30, a security menu 40, a device setting menu 50, a test page print menu 60, and a print basic-setting menu 70.

The general menu 10 is provided with the print basic-setting menu 70 and the test page print menu 60 in a subordinate relationship and the share menu 20 is provided with a menu for sharing the printer with other host(s). The port menu 30 is provided with a menu for setting and adding a port for transmitting print data from the host to the printer or the like, and the security menu 40 is provided with a menu for setting use authority when a user who has logged into the host accesses the printer. The print basic-setting menu 70 includes options for setting print quality, print orientation, or the like.

As illustrated in FIG. 1A, the conventional user interface screen has one or more menu groups (for example, the general menu 10, the share menu 20, the port menu 30, the security menu 40, and the device setting menu 50) classified according to similarity of individual functions provided in each menu of the printer driver program.

FIG. 1B illustrates a layout menu group 70a displayed on the display section when the print basic-setting menu 70, which is subordinate to the general menu 10, is selected among the menus illustrated in FIG. 1A.

The layout menu group 70a is subordinate to the print basic-setting menu 70 and includes an orientation menu 71a for setting paper orientation, a both-side print menu 72a for setting both-side printing, a page sequence menu 73a for setting a printing sequence, an N-UP menu 74a for printing plural pages on one side of a paper, and a high grade menu 80 subordinate to the layout menu group 70a.

As described above, a user interface screen for a conventional driver program hierarchically classifies individual functions provided in the driver program into menu groups, subordinate menus belonging to the menu groups, and secondary subordinate menus belonging to the subordinate menus.

FIG. 1C illustrates a hierarchical structure of the conventional user interface screens of FIGS. 1A and 1B. The conventional user interface screen illustrated in FIG. 1C presents sub-menus displayed when the print basic-setting menu 70 is selected in the user interface screen of FIG. 1A and then the high grade menu 80 is selected from the user interface screen of FIG. 1B. Referring to FIG. 1C, the sub-menus displayed when the high grade menu is selected are a paper output menu 81, a graphic menu 82, a document option menu 83, and a printer function menu 84. If the user wishes to set print options in a desired menu belonging to another menu group (any one of menu groups 10 to 80) after setting print options in a menu belonging to a currently displayed menu group in the conventional user interface screen having the hierarchical structure illustrated in FIG. 1C, the user must move between the individual menu groups 10 to 80 to select the desired menu.

That is, although the print options, which the user may set for a document file, are preset according to respective functions by a manufacturer for the purpose of conveniently using the driver program, the print options preset by the manufacturer are not convenient for all users. It is inconvenient for the user to have to enter all of the menu groups to adjust the print options if the print options are included in various menu groups different from each other.

That is, the conventional method of displaying a user interface has a problem in that the effort required of the user to set options increases as the number of options for the user to set for a document file increases and the number of options located in different menu groups increases.

In addition, in configuring a conventional user interface screen for an image input apparatus, such as a scanner, an image forming apparatus, such as a multi-functional peripheral device, a printer, or a device removable from a host, such as a video card, an audio card, or a wired or wireless network card, problems similar to those described above arise, whereby it is very inconvenient to set options for a driver program through the conventional user interface screen.

### SUMMARY OF THE INVENTION

Accordingly, the present general inventive concept provides a host device, which allows a user to conveniently use it, by providing a user interface to set options of a driver program to drive a device removable from the host device such that independent menu groups of the user interface can be entirely or selectively independently displayed on a display section of the host device.

Additional aspects of the present general inventive concept will be set forth in part in the description which follows and, in part, will be obvious from the description, or may be learned by practice of the general inventive concept.

The foregoing and/or other aspects of the present general inventive concept may be achieved by providing a host device including one or more menu groups provided in a driver program to drive an external device connectable to the host device and to set driving options of the external device, a user interface section connected to the one or more menu groups to provide a user interface screen to independently display the one or more menu groups separately with respect to each other, and a display section to display the user interface screen provided by the user interface section.

The user interface section may include an identifier information memory section to store unique identifier information corresponding to each of the one or more menu groups, a menu group controller to determine a manner of displaying the one or more menu groups on the user interface screen and to control the one or more menu groups to be independently displayed on the user interface screen with respect to each other, and a setting value memory section to store driving option setting values selected in sub-menus of the one or more menu groups.

The host device may further include a print data generation section to receive the driving option setting values stored in the setting value memory section and to generate print data corresponding to a document file transmitted from an application according to the received driving option setting values.

The external device may be wiredly or wirelessly connected to the host.

The external device may include an image forming device including one of a multi-functional peripheral device, and a printer, or an image input device including one of a scanner, a digital camera, a digital camcorder, a mobile phone, and a PDA.

The external device may include one of a video card, an audio card, and a wired or wireless network card.

The user interface screen may include a driver registration information screen to be displayed at one side of the display section and a print basic-setting screen and one or more of the menu groups to be independently displayed at another side of the display section.

The user interface screen may include a signal transmitting unit to independently display the one or more menu groups as a single menu group on the user interface screen.

The signal transmitting unit may include a deployment button.

A selected menu group among the one or more menu groups displayed on the screen may be displayed on the display section in an activated state.

A sequential one of the one or more of the menu groups may be displayed on the display section and deployed from a predetermined area of the user interface screen when the predetermined area of the user interface screen is selected.

A certain unique value may be set in advance for the one or more menu groups, and a sequence and an orientation of the deployed sequential one of the one or more menu groups may be set according to the set value.

The one or more menu groups may be provided as icons, and sub-menus of the one or more menu groups may be displayed at a predetermined side of the display section.

The driver registration information screen may include a functional button to hide the driver registration information screen and the one or more menu groups.

The driver registration information screen may include a functional button to close the driver registration information screen and the one or more menu groups.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIGS. 1A to 1C illustrates conventional user interface screens for a printer driver program installed in a host device;

FIG. 2 illustrates a block diagram of a driver program installed in a host device according to an embodiment of the present general inventive concept;

FIG. 3A to 3C illustrate configurations of a user interface screen for a printer driver according to embodiments of the present general inventive concept;

FIG. 4 illustrates a configuration a user interface screen according to another embodiment of the present general inventive concept;

FIG. 5 illustrates a configuration of a user interface screen according to another embodiment of the present general inventive concept;

FIG. 6 illustrates a configuration of a user interface screen according to another embodiment of the present general inventive concept; and

FIG. 7 illustrates a configuration of a user interface screen according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

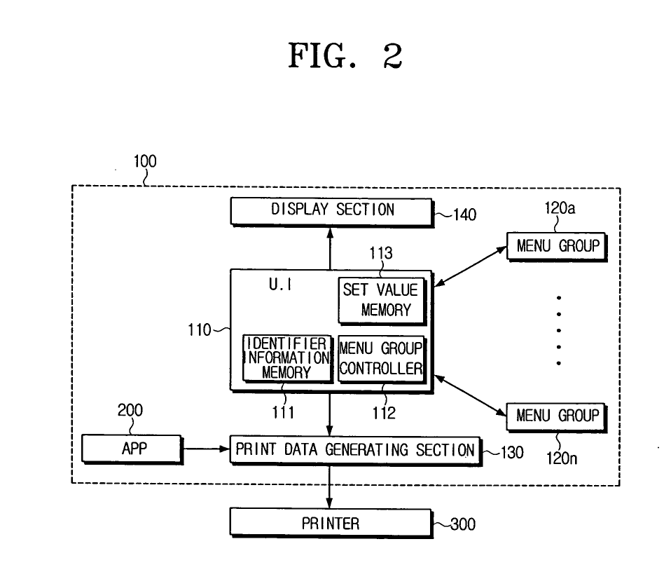

FIG. 2 is a block diagram illustrating a driver program installed in a host device 100 according to an embodiment of the present general inventive concept. As illustrated in FIG. 2, the driver program drives a printer 300 connectable to the host device 100.

Referring to FIG. 2, the host device 100 includes a user interface section 110 connected with one or more menu groups 120a to 120n, a display section 140 to display a user interface screen provided by the user interface section 110, and a print data generation section 130 to generate print data corresponding to a document file transmitted from an application program (APP) 200 and to transmit the generated print data to the printer 300.

When the driver program is requested in the host device 100, the user interface section 110 controls the display section 140 to display the user interface screen to set various print options of the driver program. The user interface section 110 controls the display section 140 to display identifiers corresponding to the menu groups 120a to 120n according to respective functions of the menu groups 120a to 120n, and when a user selects one or more of the identifiers displayed on display section 140, the user interface section 110 controls the display section 140 to display the menu groups 120a to 120n corresponding to the selected identifiers on the display section 140. That is, when the user selects a desired one of the menu groups 120a to 120n by selecting the corresponding identifier displayed on the user interface screen using a mouse, or the like, the desired menu group is displayed on the display section 140. Individual menu groups are independently displayed on the display section 140 with respect to each other.

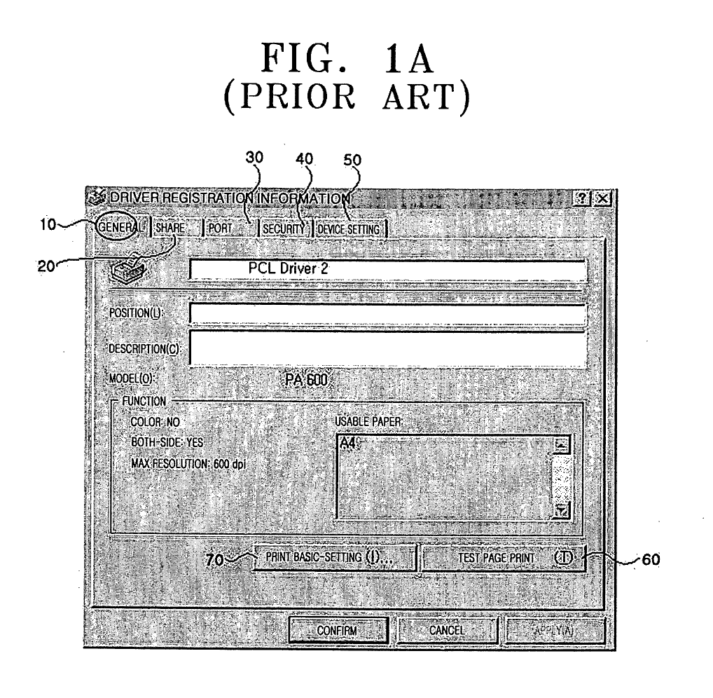

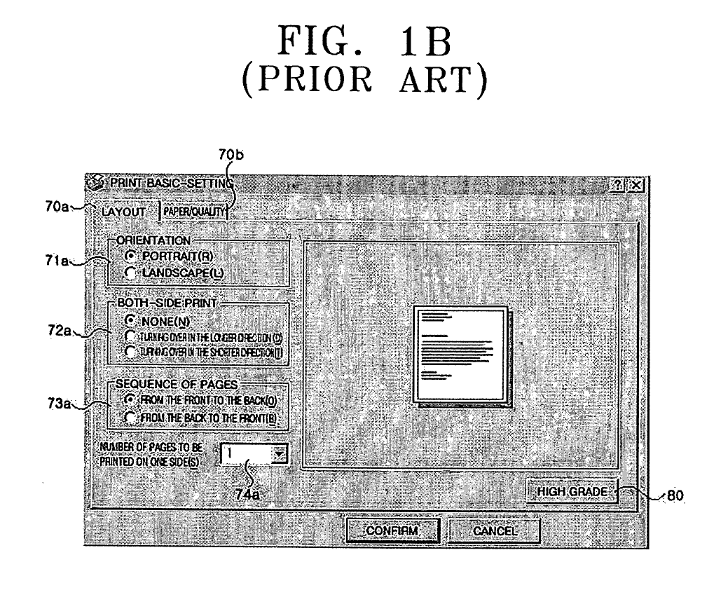

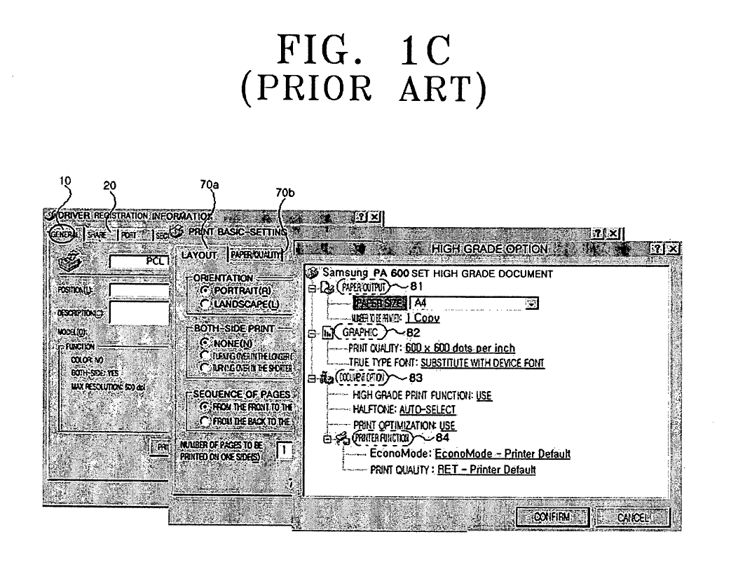

The user interface section 110 includes an identifier information memory 111, a menu group controller 112, and a set value memory 113 to store values of the print options set by the user. The identifier information memory 111 stores unique IDs (i.e. the identifiers) corresponding to the individual menu groups 120a to 120n. The user interface section 110 displays the user interface screen corresponding to the menu groups 120a to 120n selected by the user on the display section 140 according to the identifier information stored in the identifier information memory 111. The selected menu group may be activated on the display section 140. The menu group controller 112 determines how to display the individual menu groups 120a to 120n on the display section 140. For example, although it is possible to hierarchically display a menu group selected by the user as illustrated in FIGS. 1A to 1C, the menu group controller 112 according to embodiments of the present general inventive concept arranges the menu groups 120a to 120n independently at a predetermined distance apart from each other on the display section 140 according to one of various configurations. For example, the menu group controller 112 may arrange the menu groups 120a to 120n to independently display driver registration information including the identifiers corresponding to the individual menu groups 120a to 120n and the individual menu groups 120a to 120n on the display section 140, or to independently display only the individual menu groups 120a to 120n on the display section 140. The menu group controller 112 may also arrange the menu groups 120a to 120n to display the menu groups 120a to 120n in a first direction or a second direction from an edge of a print basic-setting screen, or to display information corresponding to options previously set in the driver program and to display the individual menu groups 120a to 120n at a predetermined side of the screen. The menu group controller 112 may also arrange the menu groups 120a to 120n to display icons corresponding to the individual menu groups 120a to 120n and to display one of the menu groups 120a to 120n corresponding to a selected icon on the display section 140 when the user selects any one of the icons.

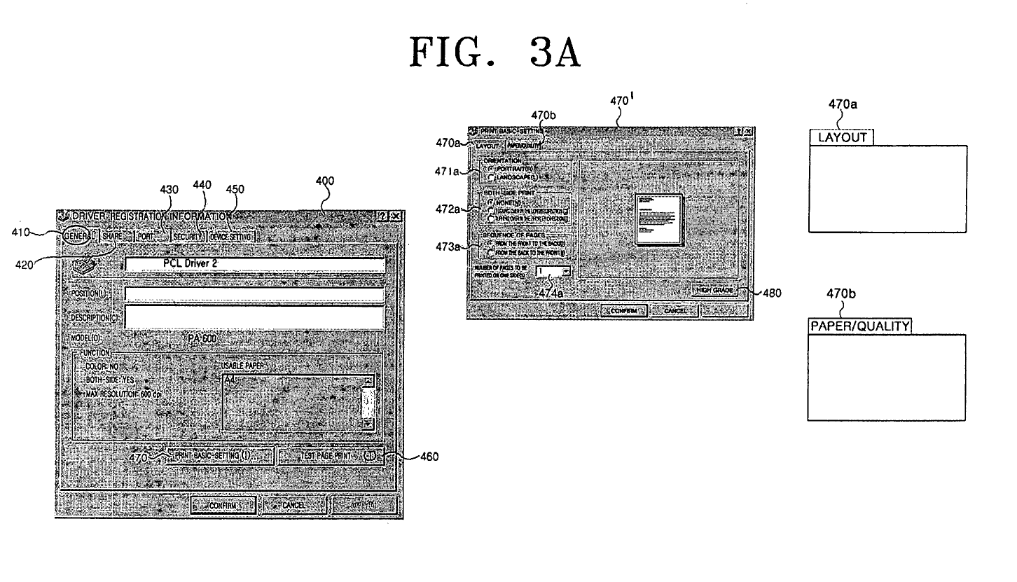

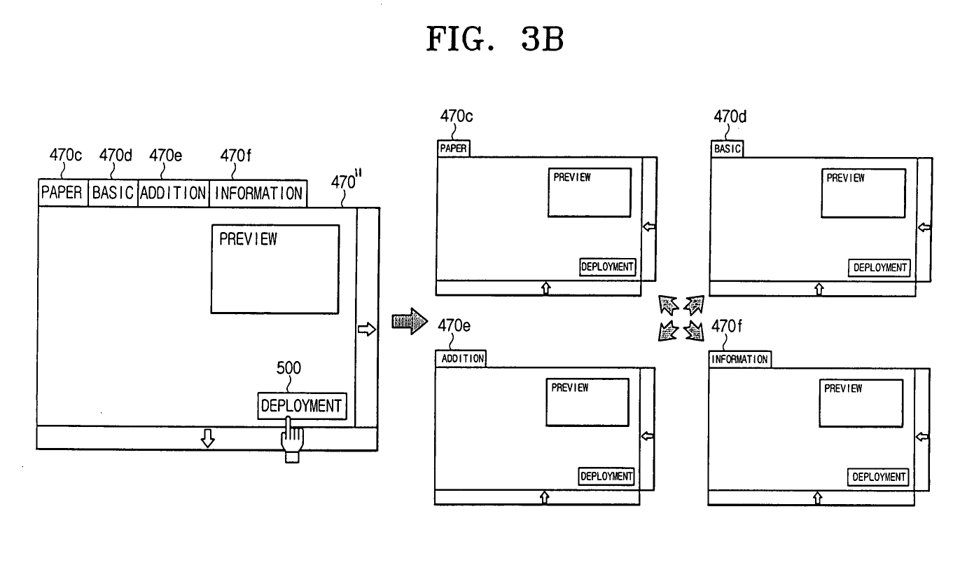

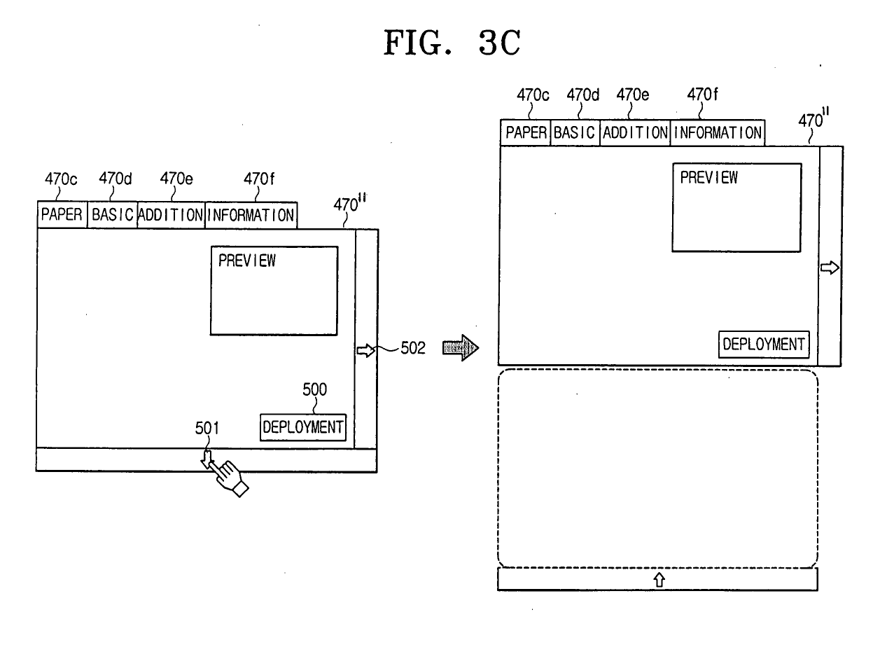

FIG. 3A to 3C illustrate configurations of a user interface screen to control the printer 300 according to embodiments of the present general inventive concept.

Referring FIG. 3A, when a print driver program is requested in the host device 100, a driver registration information screen 400 of the print driver program can be displayed at a first side of the display section 140, and a print basic-setting screen 470′, a layout menu group 470a, a paper and quality menu group 470b can be independently arranged at a second side of the display section 140. The driver registration information screen 400 can include a general menu group 410, a share menu group 420, a port menu group 430, a security menu group 440, and a device setting menu group 450. The general menu group 410 can include a print basic-setting button 470 and a test page print button 460. As illustrated in FIG. 3A, the print basic-setting screen 470′ is independently displayed at the second side of the display section 140 when a user selects the print basic-setting button 470.

The layout and paper and quality menu groups 470a and 470b are automatically displayed independently from the print-basic setting screen 470′ when the user selects the print basic-setting button 470 provided in the driver registration information screen 400, even if the user does not select the layout menu group 470a or the paper and quality menu group 470b provided in the print basic-setting screen 470′.

Accordingly, if the user wishes to set a paper orientation to “landscape,” it is sufficient only to click an orientation setting menu 471a of the layout menu group 470a displayed independently of the print basic-setting screen 470′, and if the user wishes to set a number of pages to be printed in an N-UP menu 474a, it is possible to instantly set the number of pages to be printed in the layout menu group 470a displayed independently of the print basic-setting screen 470. The user can also adjust options in a both-side print menu 472a and a sequence of pages menu 473a of the layout menu group 470 and open a high grade menu 480. For the paper and quality menu group 470b, it is possible to set print options thereof in a similar manner as setting the options in the layout menu group 470a. Therefore, the user need not select the identifiers corresponding to the layout menu group 470a and the paper quality menu group 470b provided in the print basic-setting screen 470 in order to set the print options thereof.

Although only the print basic-setting screen 470′ is depicted in detail in FIG. 3A, the share menu group 420, the port menu group 430, the security menu group 440, the device setting menu group 450, and the high grade menu 480 can be also displayed with respective sub-menus in a similar manner to the print basic-setting screen 470′.

FIG. 3B illustrates a configuration of the user interface screen to control the printer 300 according to another embodiment of the present general inventive concept.

Referring to FIG. 3B, when the print basic-setting button 470 of the driver registration information screen 400 of FIG. 3A is selected by the user, a print basic-setting screen 470″ may be displayed on the display section 140 according to another embodiment of the present general inventive concept. When the user selects a deployment button 500 of the print basic-setting screen 470″, a paper menu group 470c, a basic menu group 470d, an additional menu group 470e, and an information menu group 470f of the print basic-setting screen 470″ are independently displayed as individual menu groups 470c-470f, as illustrated in FIG. 3B, and the individual menu groups 470c-470f are displayed at a predetermined distance apart from each other. The deployment button 500 is merely an example, and therefore, any adequate signal transmitting medium may alternatively be employed.

FIG. 3C illustrates a configuration of the user interface screen to control the printer 300 according to yet another embodiment of the present general inventive concept.

When the print basic-setting button 470 of the driver registration information screen 400 of FIG. 3A is selected by the user, the print basic-setting screen 470″ may be displayed on the display section 140 as illustrated in FIG. 3B. The menu groups 470c-470f, however, are displayed independently form the print basic-setting screen 470″ according to yet another embodiment of the present general inventive concept. Referring to FIG. 3C, when the user selects a first arrow 501 of the print basic-setting screen 470″, one of the menu groups 470c-470f is displayed in a first direction from a first predetermined area of the print basic-setting screen 470″. If the user selects a second arrow 502, one of the menu groups 470c-470f is displayed in a second direction from a second predetermined area of the print basic-setting screen 470″. A user may allocate in advance certain unique values to the menu groups 470c-470f to determine a sequence and an orientation of the menu groups 470c-470f being displayed from the first or second predetermined area of the print basic setting screen 470″ according to the allocated values. The manufacturer or the user may allocate the values.

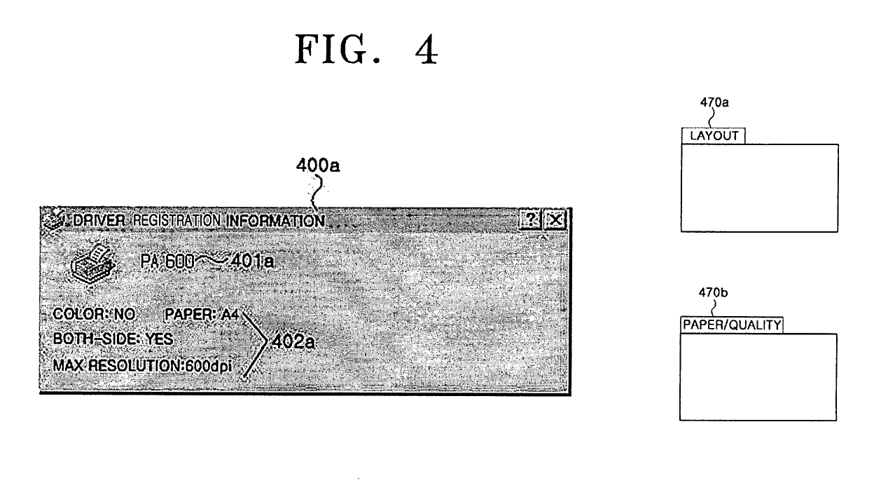

FIG. 4 illustrates a configuration of a user interface screen according to an embodiment of the present general inventive concept.

Referring to FIG. 4, the user interface screen includes a driver registration information screen 400a to indicate a state of print options 401a and 402a as the print options 401a and 402a are previously set, instead of the driver registration information screen 400 illustrated in FIG. 3A.

The driver registration information screen 400a indicating the previously set print options 401a and 402a and individual menu groups 470a and 470b are displayed on the display section 140, and the user can set the print options 401a and 402a through the menu groups 470a and 470b after referring to values of the previously set printing options 401a and 402a indicated in the driver registration information screen 400a. Although “model name” (PA 600) of the printer, “print mode” (no color print) of the printer, “selection of both-side print,” “selected paper size” (A4), and “resolution” (600 dpi) set in the printer are the print options 401a and 402a indicated in the driver registration information screen 400a as illustrated in FIG. 4, these are merely examples, and the driver registration information screen 400a may additionally indicate information related to “paper orientation” to be printed, “paper type,” “print quality,” and “basic font,“ or information previously set for other various print options.

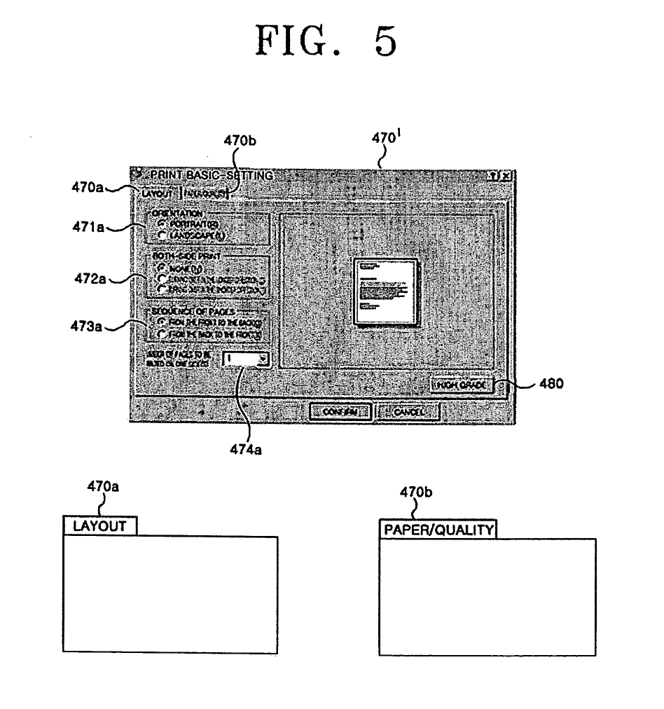

FIG. 5 illustrates a configuration of a user interface screen according to another embodiment of the present general inventive concept.

The user interface screen of FIG. 5 is characterized by that the individual menu groups 470a and 470b provided in the print basic-setting screen 470′ of FIG. 3A are deployed at a predetermined area on a display section 140. For example, the menu groups 470a and 470b can be arranged at one of a left, a right, an upper, a lower, and a central area on the display section 140. Although only the print basic-setting screen 470′ is depicted in detail in FIG. 5, the share menu group 420, the port menu group 430, the security menu group 440, the device setting menu group 450 (see FIG. 3A), and a high grade menu 480 can be also displayed with respective sub-menus in a similar manner to the print basic-setting screen 470′.

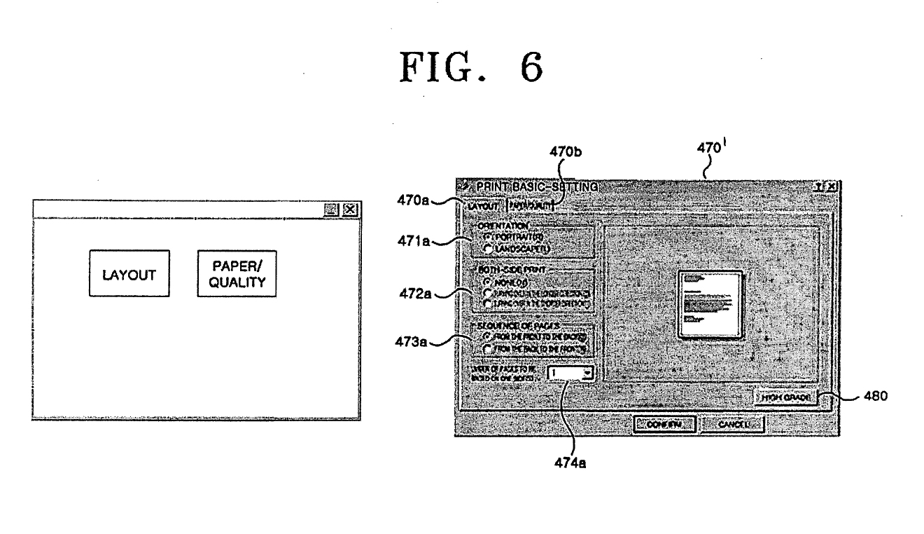

FIG. 6 illustrates a configuration of a user interface screen according to another embodiment of the present general inventive concept.

Referring to FIG. 6, the individual menu groups 470a and 470b of the print basic-setting screen 470′ of FIG. 3A are provided in the form of icons and sub-menus corresponding to the menu groups 470a and 470b to respond to an input device (e.g., mouse, key board, touch screen, stylus pen or the like) usable with the host device 100. The icons can be deployed at a left area or a first predetermined area on the display section 140. As illustrated in FIG. 6, the icon corresponding to the layout menu group 470a is selected, and the sub-menus 471a, 472a, 473a, 474a subordinate to the layout menu group 470a are displayed on the print basic-setting screen 470′ at a right area or a second predetermined area of the display section 140. The user can instantly set desired print options by selecting the sub-menus 471a, 472a, 473a, 474a of the layout menu group 470a displayed in the display section 140 through an input device.

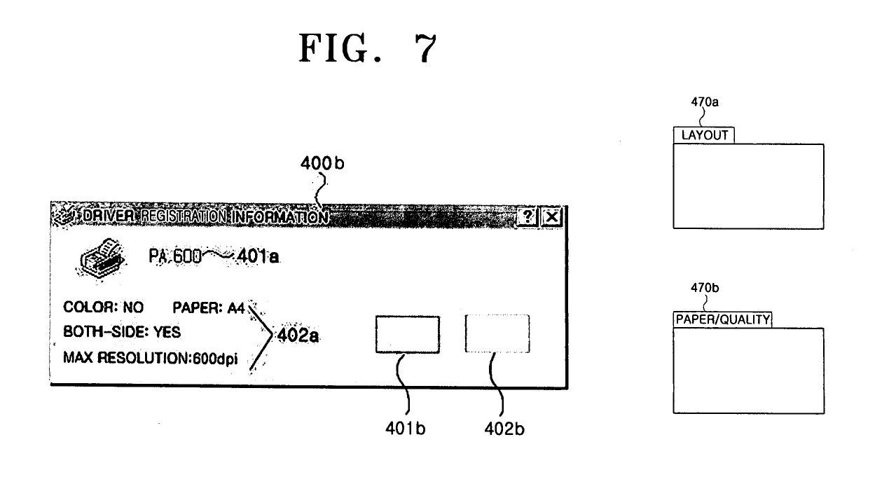

FIG. 7 illustrates a configuration of a user interface screen according to another embodiment of the present general inventive concept.

Referring to FIG. 7, a driver registration information screen 400b is similar to the driver registration information screen 400a of FIG. 4, and additionally includes a first functional button 401b to hide the driver registration information screen 400b and the displayed menu groups 470a and 470b and a second functional button 402b to close the driver registration information screen 400b and the displayed menu groups 470a and 470b. The first and second functional buttons 401b and 402b may be similarly applied to the embodiments of FIGS. 3A and 4. The driver registration information screen 400b and the menu groups 470a and 470a displayed independently from the driver registration information screen 400b are not displayed any longer if the first functional button 401b of the driver registration information screen 400b is selected by an input device.

For example, if the menu groups 470a and 470b displayed independently from the driver registration information screen 400b are driven in a Windows series operation system (for example, WINDOWS 2000 PROFESSIONAL) available from Microsoft Corporation, the driver registration information screen 400b and the menu group 470a, 470b are not displayed on a background-image provided in the Windows operation system.

Likewise, if the second functional button 402b is selected on the driver registration information screen 400b, the driver registration information screen 400b and the menu groups 470a and 470b are all closed.

Although the embodiments of the present general inventive concept been described mainly with reference to deployment of user interface screens of a printer driver program, the embodiments of the present general inventive concept can be similarly applied to user interface screens of driver programs to drive all types of interface cards requiring installment of a driver program after being connected to the host device.

For example, the embodiments of the present general inventive concept can be applied to user interface screens to control an image input device, such as a scanner, a digital camera, a digital camcorder, a mobile phone, and a PDA, an image forming device, such as a multi-functional device, a printer, and a device connectable to a host device, such as a video card, an audio card, and a wired or wireless network card.

Because user interface screens for driver programs of such a network card and a video card are very similar to those of a printer driver program in configuration, the description thereof is omitted in order to avoid overlapping in the drawings and description. However, the present general inventive concept is not limited to the exemplified user interfaces to drive a printer.

The embodiments of the present general inventive concept may be embodied as executable code in computer readable media including storage media such as magnetic storage media (ROMs, RAMs, floppy disks, magnetic tapes, etc.), optically readable media (CD-ROMs, DVDs, etc.), and carrier waves (transmission over the Internet).

As described above, if a user installs a driver program to drive an external device connectable to a host device, the host device allows the user to conveniently set driving options related to the external device in the installed driver program by reducing disadvantages related with moving between menu groups in a user interface of the driver program.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A host device comprising:
one or more menu groups provided in a driver program to drive an external device connectable to the host device and to set driving options of the external device;
a user interface section connected to the one or more menu groups to provide a user interface screen to independently display the one or more menu groups separately with respect to each other; and
a display section to display the user interface screen provided by the user interface section.

2. The host device as claimed in claim 1, wherein the user interface section comprises:
an identifier information memory section to store unique identifier information corresponding to each of the one or more menu groups;
a menu group controller to determine a manner of displaying the one or more menu groups on the user interface screen, and to control the one or more menu groups to be independently displayed on the user interface screen with respect to each other; and
a setting value memory section to store driving option setting values selected in sub-menus of the one or more menu groups.

3. The host device as claimed in claim 2, further comprising:
a print data generation section to receive the driving option setting values stored in the setting value memory section and to generate print data corresponding to a document file transmitted from an application according to the received driving option setting values.

4. The host device as claimed in claim 3, wherein the external device comprises an image forming device comprising one of a multi-functional peripheral device and a printer, or an image input device comprising one of a scanner, a digital camera, a digital camcorder, a mobile phone, and a personal digital assistant (PDA).

5. The host device as claimed in claim 1, wherein the external device is wiredly or wirelessly connected to the host.

6. The host device as claimed in claim 1, wherein the external device comprises one of a video card, an audio card, and a wired or wireless network card.

7. The host device as claimed in claim 1, wherein the user interface screen comprises a driver registration information screen displayed at one side of the display section and a print basic-setting screen and one or more of the menu groups independently displayed at another side of the display section.

8. The host device as claimed in claim 7, wherein the driver registration information screen comprises a functional button to hide the driver registration information screen and the one or more menu groups.

9. The host device as claimed in claim 7, wherein the driver registration information screen comprises a functional button to close the driver registration information screen and the one or more menu groups.

10. The host device as claimed in claim 1, wherein the user interface screen comprises a signal transmitting unit to independently display the one or more menu groups as a single menu group on the user interface screen.

11. The host device as claimed in claim 10, wherein the signal transmitting unit comprises a deployment button.

12. The host device as claimed in claim 10, wherein a selected menu group among the one or more menu groups displayed on the user interface screen is displayed on the display section in an activated state.

13. The host device as claimed in claim 1, wherein a sequential one of the one or more menu groups is displayed on the display section and deployed from a predetermined area of the user interface screen when the predetermined area of the user interface screen is selected.

14. The host device as claimed in claim 13, wherein a certain unique value is set in advance for the one or more menu groups, and a sequence and an orientation of the deployed sequential one of the one or more menu groups is determined according to the set value.

15. The host device as claimed in claim 1, wherein the one or more menu groups are provided as icons, and sub-menus of the one or more menu groups are displayed at a predetermined side of the display section.

16. A host device connectable with an external apparatus, the host device comprising:
a display;
a driver program having adjustable driving options to control the external apparatus; and
a user interface comprising a plurality of menus displayable on the display, each having one or more respective sub-menus displayable on the display separately from each other and from the respective one of the plurality of menus to adjust the driving options of the driving program.

17. The host device as claimed in claim 16, wherein the user interface further comprises a plurality of selectable identifiers displayable on the display and corresponding to the plurality of menus, and when one of the plurality of identifiers is selected, the corresponding one of the plurality of menus and the respective sub-menus are simultaneously displayed on the display separately with respect to each other.

18. The host device as claimed in claim 16, wherein each of the plurality of menus comprises a selectable deployment button, and when the deployment button is selected the respective sub-menus are displayed on the display.

19. The host device as claimed in claim 18, wherein when the deployment button is selected the respective sub-menus are displayed on the display separated by a predetermined distance from each other.

20. The host device as claimed in claim 16, wherein each of the plurality of menus comprises one or more selectable portions, and when one of the one or more portions is selected, the respective sub-menus sequentially extend from the selected portion to be displayed on the display.

21. The host device as claimed in claim 20, wherein the respective sub-menus sequentially extend from the selected portion in an order determined by a value set by one of a user and a manufacturer.

22. The host device as claimed in claim 16, wherein the user interface further comprises a driver information screen displayable on the display to display values of the driving options, and the plurality of menus and the respective sub-menus are simultaneously displayable on the display without overlapping with the driver information screen.

23. The host device as claimed in claim 22, wherein the driver information screen comprises one or more control portions to simultaneously control the driver information screen and each of the menus and the respective sub-menus displayed on the display.

24. The host device as claimed in claim 23, wherein the one or more control portions comprise a hide button to hide the driver information screen and each of the menus and the respective sub-menus displayed on the display and a close button to close the driver information screen and each of the plurality of menus and the respective sub-menus displayed on the display.

25. The host device as claimed in claim 16, wherein each of the plurality of menus and the respective sub-menus are displayable on the display at a predetermined portion of the display.

26. The host device as claimed in claim 16, wherein when one of the plurality of menus is displayed on the display, the respective sub-menus are automatically displayed on the display separately from the displayed one of the plurality of menus such that the respective sub-menus do not overlap with the displayed menu.

27. The host device as claimed in claim 16, wherein the user interface further comprises a selectable icon corresponding to each of the respective one or more sub-menus of each of the plurality of menus and displayable on the display when the respective one of the plurality of menus is displayed, and when one of the selectable icons is selected, the corresponding sub-menu is displayed on the display.

28. The host device as claimed in claim 27, wherein when the one of the selectable icons is selected, the corresponding sub-menu is displayed within the respective one of the plurality of menus on the display.

29. A user interface displayable on a display of a host to control a driver program of the host, the user interface comprising:
a first menu displayed on the display and comprising a plurality of selectable menu identifiers; and
a plurality of second menus, each of the plurality of second menus corresponding to one of the plurality of selectable menu identifiers and being simultaneously displayed on different areas of the display separately from the first menu when the corresponding one of the plurality of selectable menu identifiers is selected.

30. The user interface as claimed in claim 29, wherein each of the plurality of second menus comprises:
one or more sub-menus displayable on the display separately from the respective one of the plurality of second menus when the respective one of the plurality of sub-menus is displayed on the display.

31. The user interface as claimed in claim 30, wherein the one or more sub-menus of each of the plurality of second menus are automatically displayed on the display separately from the respective one of the plurality of second menus and separately from each other when the respective one of the plurality of second menus is displayed on the display.

32. The user interface as claimed in claim 30, wherein each of the plurality of second menus further comprises a deployment button, and the one or more sub-menus of each of the plurality of second menus are displayed on the display separately from the respective one of the plurality of second menus and at a predetermined distance apart from each other when the respective one of the plurality of second menus is displayed on the display and the deployment button is selected.

33. The user interface as claimed in claim 30, wherein each of the plurality of second menus further comprises one or more selectable edge portions, and the one or more sub-menus of each of the plurality of second menus sequentially extend from one of the one or more selectable edge portions of the respective one of the plurality of second menus to be displayed on the display when the respective one of the plurality of second menus is displayed on the display and the one of the selectable edge portions is selected.

34. The user interface as claimed in claim 30, wherein each of the plurality of second menus comprises one or more icons corresponding to the one or more sub-menus to be displayed on the display when the respective one of the plurality of second menus is displayed on the display, and selectable to display the corresponding one-or more sub-menus on the display separately from the respective one of the plurality of the second menus.

35. A user interface displayable on a display of a host to control a driver program of the host, the user interface comprising:
a driver information screen to display values of driving options of the driver program on the display; and
a plurality of menus displayed on the display separately from each other and from the driver information screen to adjust the values of the driving options.

36. The user interface as claimed in claim 35, wherein the driver information screen comprises a hide button to hide the driver information screen and the plurality of menus and a close button to close the driver information screen and the plurality of menus.

37. A method of displaying a user interface on a display of a host device, the method comprising:
displaying a first menu comprising a plurality of selectable identifiers corresponding to a plurality of second menus; and
displaying a corresponding one of the plurality of second menus separate from the first menu when one of the plurality selectable identifiers is selected.

38. The method as claimed in claim 37, further comprising:
automatically displaying one or more sub-menus of the displayed corresponding one of the plurality of second menus separately from each other and from the displayed corresponding one of the plurality of second menus when the corresponding one of the plurality of second menus is displayed.

39. The method as claimed in claim 37, further comprising:
selecting a selectable portion of the displayed corresponding one of the plurality of second menus; and
displaying all of one or more sub-menus of the displayed corresponding one of the plurality of second menus separately from each other and from the displayed corresponding one of the plurality of second menus when the selectable portion is selected.

40. The method as claimed in claim 37, further comprising:
selecting a selectable edge portion of the displayed corresponding one of the plurality of second menus; and
sequentially displaying one or more sub-menus of the displayed corresponding one of the plurality of second menus by extending one of the one or more sub-menus from the selectable edge portion when the selectable edge portion is selected.

41. The method as claimed in claim 37, further comprising:
displaying one or more icons corresponding to one or more sub-menus of the displayed corresponding one of the plurality of second menus when the corresponding one of the plurality of second menus is displayed; and
displaying a corresponding one of the one or more sub-menus separately from the displayed corresponding one of the plurality of second menus when one of the one or more icons is selected.

42. A method of displaying a user interface on a display of a host device to control a driver program of the host device, the method comprising:
displaying values of driving options of the driver program in an information menu; and
displaying a plurality of menus separately from the information menu to adjust the values of the driving options.

43. The method as claimed in claim 42, further comprising:
simultaneously controlling the information menu and the plurality of menus by selecting a portion of the information menu.

44. A computer readable recording medium containing a method of displaying a user interface on a display of a host device, the method comprising:
displaying a first menu comprising a plurality of selectable identifiers corresponding to a plurality of second menus; and
displaying corresponding ones of the plurality of second menus separate from the first menu when one of the plurality selectable identifiers is selected.

45. A computer readable recording medium containing a method of displaying a user interface on a display of a host device, the method comprising:
displaying values of driving options of the driver program in an information menu; and
displaying a plurality of menus separately from the information menu to adjust the values of the driving options.

46. The computer readable recording medium as claimed in claim 45, wherein the displaying of the plurality of menus comprises:
simultaneously displaying the plurality of menus on separate areas of a display.
